(19) United States
(12) Patent Application Publication
(10) Pub. No.: US 2014/0152693 A1
(43) Pub. Date: Jun. 5, 2014

(54) CONTROLLING DISPLAY OF COMMAND SPACE USING MULTI-STATE ELEMENT

(71) Applicant: MICROSOFT CORPORATION, Redmond, WA (US)

(72) Inventors: Samuel Radakovitz, Puyallup, WA (US); Melissa Kerr, Redmond, WA (US); Krista Bendig, Redmond, WA (US); Theodor Scott, Redmond, WA (US); Andrew Fomichev, Sammamish, WA (US); Elaine Law, Redmond, WA (US); Clinton Covington, Redmond, WA (US)

(73) Assignee: MICROSOFT CORPORATION, Redmond, WA (US)

(21) Appl. No.: 13/705,057

(22) Filed: Dec. 4, 2012

(51) Int. Cl. G06F 3/0481

(52) U.S. Cl. CPC G06F 3/0481
USPC 345/629

(57) ABSTRACT

A multi-state viewing mode user interface (UI) element is used to switch between different viewing modes on a display of a computing device. A user may switch between hidden mode where commands are hidden, a collapsed mode where a portion of the commands are hidden, and an expanded mode where the commands are shown on the display. The viewing mode UI element may remain displayed such that a user may interact with the element to switch to another viewing mode. A trigger zone UI element may be displayed that when activated temporarily displays commands that are hidden according to the selected viewing mode. Other UI elements (e.g. closing the application) may also be shown. A selected viewing mode may persist across an application closing and re-opening. A status UI element may also be surfaced (e.g. temporarily) to indicate various events.

### BACKGROUND

Many computing devices have a limited display area. In some cases, User Interface (UI) elements are hidden from view while displayed in a full screen mode such that content that is associated with an application may utilize more of the display space. A user may toggle between the full screen mode and a non-full screen mode.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A multi-state viewing mode user interface (UI) element is used to switch between different viewing modes on a display of a computing device. A user may switch between hidden mode where commands are hidden, a collapsed mode where a portion of the commands are hidden, and an expanded mode where the commands are shown on the display. The viewing mode UI element may remain displayed such that a user may interact with the element to switch to another viewing mode. A trigger zone UI element may be displayed that when activated temporarily displays commands that are hidden according to the selected viewing mode. Other UI elements (e.g. closing the application) may also be shown. A selected viewing mode may persist across an application closing and re-opening. A status UI element may also be surfaced (e.g. temporarily) to indicate various events. The selection of the different viewing modes may be made using touch gestures and/or non-touch interaction.

### BRIEF DESCRIPTION OF THE DRAWINGS

FIG. 1 shows a system for selecting a viewing mode for an application;

FIG. 2 shows an exemplary display of a multi-state user interface element to change viewing modes;

FIG. 3 illustrates displays showing different viewing modes selected;

FIG. 4 illustrates using touch gestures to change the viewing mode;

FIG. 5 shows interaction with a trigger zone UI element;

FIG. 6 illustrates exemplary displays showing different embodiments;

FIG. 7 shows an illustrative processes for changing viewing mode for an application;

FIG. 8 illustrates an exemplary system for changing viewing modes; and

FIGS. 9-11 and the associated descriptions provide a discussion of a variety of operating environments in which embodiments of the invention may be practiced.

### DETAILED DESCRIPTION

Referring now to the drawings, in which like numerals represent like elements, various embodiment will be described.

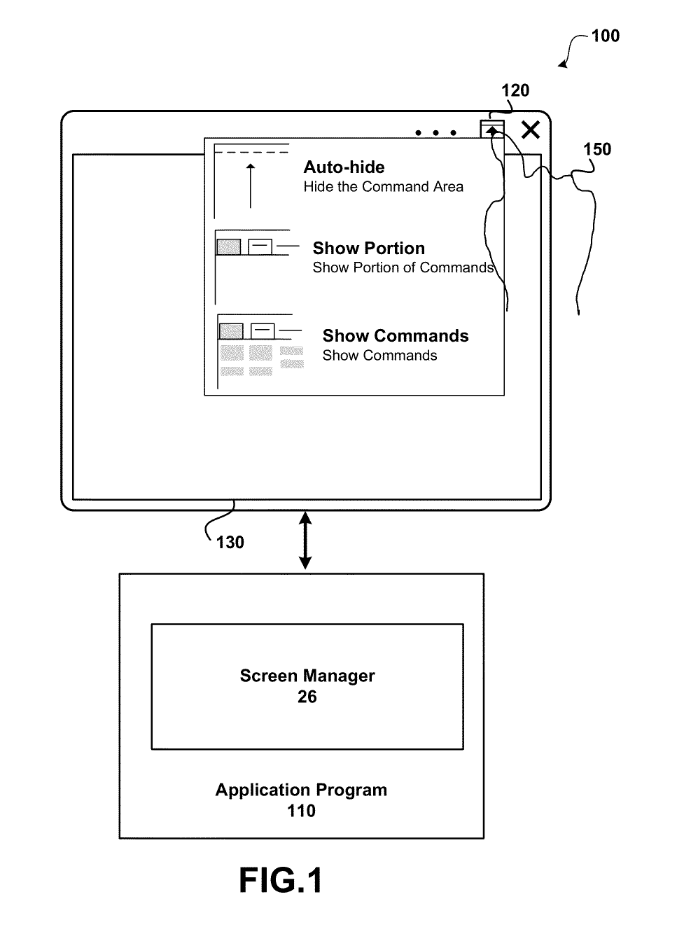

FIG. 1 shows a system for selecting a viewing mode for an application. As illustrated, system 100 includes application program 110, screen manager 26 and touch screen input device/display 115.

In order to facilitate communication with the screen manager 26, one or more callback routines, may be implemented. According to one embodiment, application program 110 is a productivity application, such as a word-processing program, that is configured to receive input from a touch-sensitive input device 115 and/or other input devices. For example, voice input, keyboard input (e.g. a physical keyboard and/or SIP), video based input, and the like. For example, screen manager 26 may provide information to application 110 in response to a user's gesture (i.e. gesture 150) selecting a user interface element, content and other touch based gestures. For example, gestures may include, but are not limited to: a pinch gesture; a stretch gesture; a select gesture (e.g. a tap action on a displayed element); a select and hold gesture (e.g. a tap and hold gesture received on a displayed element); a swiping action and/or dragging action; and the like.

System 100 as illustrated comprises a touch screen input device/display 115 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

Screen manager 26 is configured to change a viewing mode between a hidden mode, a collapsed mode and an expanded mode. A multi-state viewing mode user interface (UI) element 120 is used to switch between different viewing modes on a display of a computing device. A user may switch between hidden mode where commands are hidden, a collapsed mode where a portion of the commands are hidden, and an expanded mode where the commands are shown on the display. According to an embodiment, the viewing mode UI element 120 remains displayed in each of the viewing modes such that a user may interact with the element to switch to another viewing mode. A trigger zone UI element is displayed when not in the expanded viewing mode that when activated temporarily displays commands that are hidden according to the currently selected viewing mode. Other UI elements (e.g. closing the application) may also be shown. The selected viewing mode persists across an application closing and re-opening. In this way, a user does not need to reselect the viewing mode each time the application is launched. Different applications may have different selected viewing states. A status UI element may also be surfaced (e.g. temporarily) to indicate various events. The selection of the different viewing modes may be made using touch gestures and/or non-touch interaction. More details regarding the viewing modes are provided below.

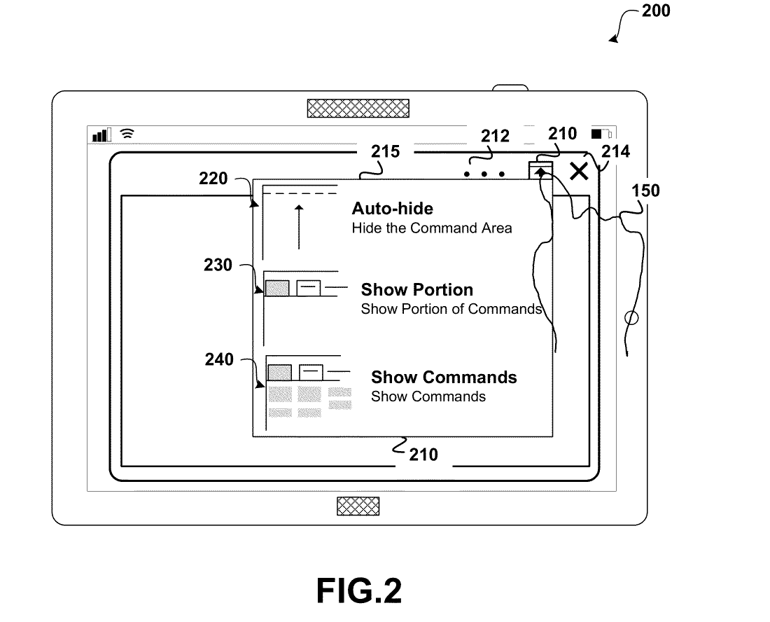

FIG. 2 shows an exemplary display of a multi-state user interface element to change viewing modes. As illustrated, FIG. 2 shows display 200 including a viewing mode UI.

The display may be shown on displays having a standard/large display (e.g. displays larger than 12 inches) as well as a device having a limited display size (e.g. a cell phone having a display of approximately 2 by 3 inches, a slate/tablet having approximately a 7-10 inch display, and/or other devices having other display sizes (e.g. 4, 5, 6,). The displays may also be shown on a touch screen.

According to an embodiment, UI element 210 is displayed near a top of the display area with a trigger zone UI element 212 and a close application UI element 214. The UI element 210 may be shown by itself and/or with other UI elements. Trigger zone UI element 212 is configured to temporarily display the commands hidden by the currently selected viewing mode. For example, a user may select trigger UI 212 to temporarily display all/portion of the commands not currently displayed. According to an embodiment, a user may tap/swipe anywhere within the top menu area that includes the trigger zone UI element to temporarily display the commands hidden by the currently selected viewing mode.

As illustrated, user 150 has selected UI element 210 that shows the hidden mode 220 option, a collapsed mode 230 option and an expanded mode 240 option.

Hidden mode option 220 when selected changes the viewing mode to a full screen mode where the display of commands is hidden from view such that more display area is used for application content. According to an embodiment, the hidden mode automatically hides a ribbon user interface, such as used by MICROSOFT productivity applications such as MICROSOFT WORD and EXCEL.

Collapsed mode option 230 when selected shows a portion of the commands. Instead of showing all of the commands displayed in an expanded mode, a portion of the commands are shown when in collapsed mode such that more display area is used for application content as compared to when all of the commands are displayed. According to an embodiment, when the collapsed mode is selected, the tabs in a ribbon user interface are shown without showing the commands associated with a currently selected tab.

Expanded mode option 230 when selected shows the commands shown with the user interface. According to an embodiment, when the expanded mode is selected, the tabs in a ribbon user interface are shown with the display of commands associated with a currently selected tab.

According to an embodiment, a currently selected viewing mode is maintained across application closings/openings. For example, if the last selected viewing mode is a collapsed viewing mode, then when the application is opened/started again the viewing mode remains collapsed. In other words, the user does not need to re-select a viewing mode each time the application is started. This may assist the user in saving the user time.

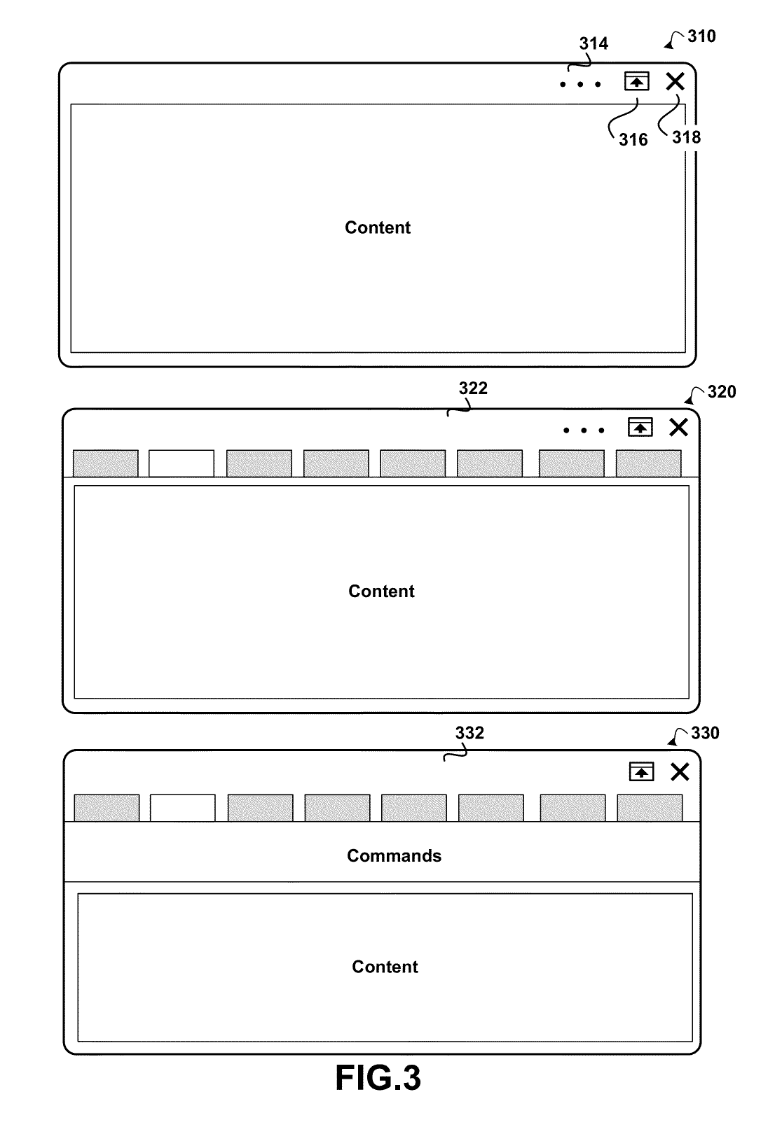

FIG. 3 illustrates displays showing different viewing modes selected. As illustrated, FIG. 3 includes display 310, display 320 and display 330.

Display 310 shows an exemplary display when the hidden mode is selected. In the current example, three different UI elements remain displayed when the hidden mode (e.g. full screen mode) is selected. The UI elements displayed include a trigger zone UI element 314, a multi-state viewing mode UI element 316 and a close application UI element 318. More or fewer UI elements may be displayed in full screen mode. According to an embodiment, the multi-state UI element 316 remains displayed regardless of any other UI elements being displayed. The UI elements displayed while in hidden mode are displayed such that they occupy a small amount of screen space. According to an embodiment, the UI elements may be displayed translucently such that content may be seen beneath a display of the remaining displayed UI element. Hidden mode includes more display room for the display of content as compared to the other viewing modes.

Display 320 shows an exemplary display when the collapsed mode is selected. In the current example, the display includes a collapsed mode showing available tabs in a ribbon user interface that may be selected without showing commands with a currently selected tab. Instead of showing a full display of the command area as displayed in expanded mode, the collapsed mode shows a portion of the commands in a smaller command display area 322 as compared to an expanded display area 33 shown in display 330.

Display 330 shows an exemplary display when the expanded mode is selected. In the current example, the display includes an expanded mode showing available tabs in a ribbon user interface that may be selected along with a display of commands for a current tab.

Different touch based gestures and/or commands may be used to change the viewing mode. For example, a user select UI element 316 to change the viewing mode. According to an embodiment, a user may also perform a touch gesture to change the viewing mode.

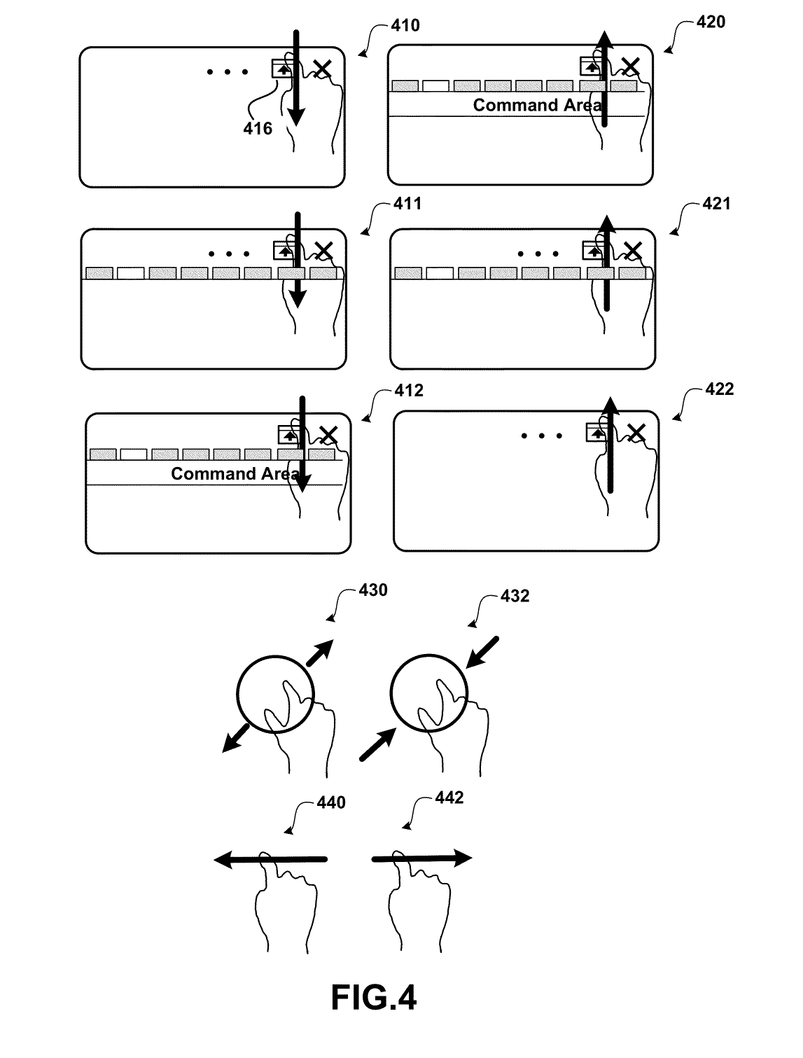

FIG. 4 illustrates using touch gestures to change the viewing mode.

For example, the user may perform a swipe gesture on/near the display of UI element 416 to change the viewing mode (e.g. swiping down selects the next viewing mode and swiping up selects a previous viewing mode).

Displays 410-412 illustrate a downward swiping action to change the viewing mode. As illustrated, a downward gesture received while in the hidden mode changes the viewing mode to the collapsed mode as illustrated in display 411. A downward gesture received while in the collapsed mode changes the viewing mode to the expanded mode as illustrated in display 412. A downward gesture received while in the expanded mode changes the viewing mode to the hidden mode as illustrated in display 410.

An upward gesture received while in the expanded mode as illustrated in display 420 changes the viewing mode to the collapsed mode as illustrated in display 421. An upward gesture received while in the collapsed mode changes the viewing mode to the collapsed mode as illustrated in display 421. An upward gesture received while in the hidden mode changes the viewing mode to the expanded mode as illustrated in display 420.

Other gestures may be used to change the selected viewing mode. For example, an expand gesture 430 and/or pinch gesture 432 may be used to change the viewing mode. A user may perform an expand gesture 430 near the UI element and/or in the command area to move to a next viewing mode (e.g. from hidden mode to collapsed mode to expanded mode). Similarly, a pinch gesture 432 may be used move to a next viewing mode (e.g. from expanded mode to collapsed mode to hidden mode).

A left gesture 440 and/or right gesture 442 may be used to cycle through the available viewing modes.

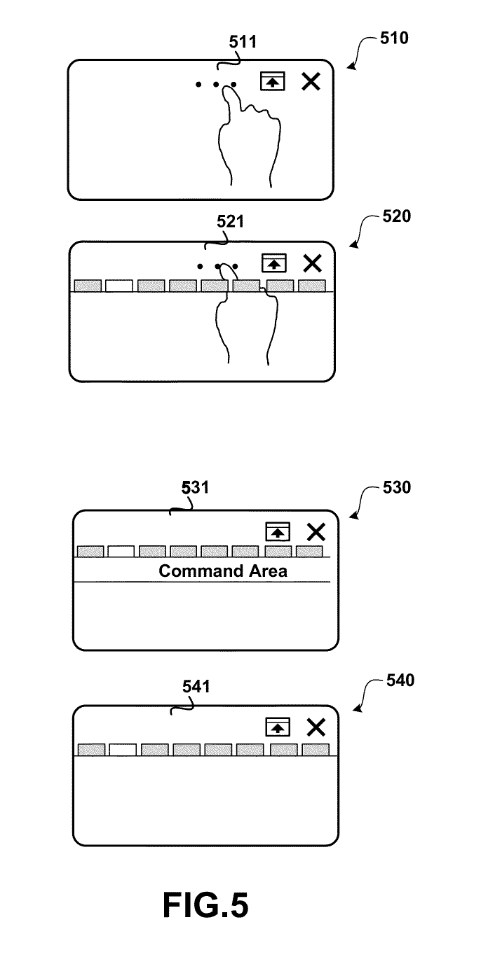

FIG. 5 shows interaction with a trigger zone UI element. As illustrated, FIG. 5 includes displays 510, 520, 530 and 540.

Display 510 illustrates a user selecting a trigger zone UI element 511. In response to the selection of UI element 510, hidden commands are temporarily displayed. For example, a portion of the hidden commands may be displayed as illustrated in display 540 or the expanded view may be temporarily displayed as illustrated in display 530. The hidden commands are temporarily displayed until an event that dismisses the temporary display of the commands is made. The event may be an event received from a user (e.g. selecting a command, selecting an area outside of the command area, . . . ) and/or an event such as a timer expiring, receiving a system notification, and the like. According to an embodiment, the temporary display is dismissed in response to the user selecting a command and/or receiving input outside of the command area.

Display 520 illustrates a user selecting a trigger zone UI element 521 when the view is a collapsed mode display. In response to the selection of UI element 521, hidden commands are temporarily displayed. In the current example, the temporarily displayed commands includes the expanded view mode as illustrated in display 530. According to an embodiment, the commands associated with a current tab are temporarily displayed in response to selection of the trigger zone UI element.

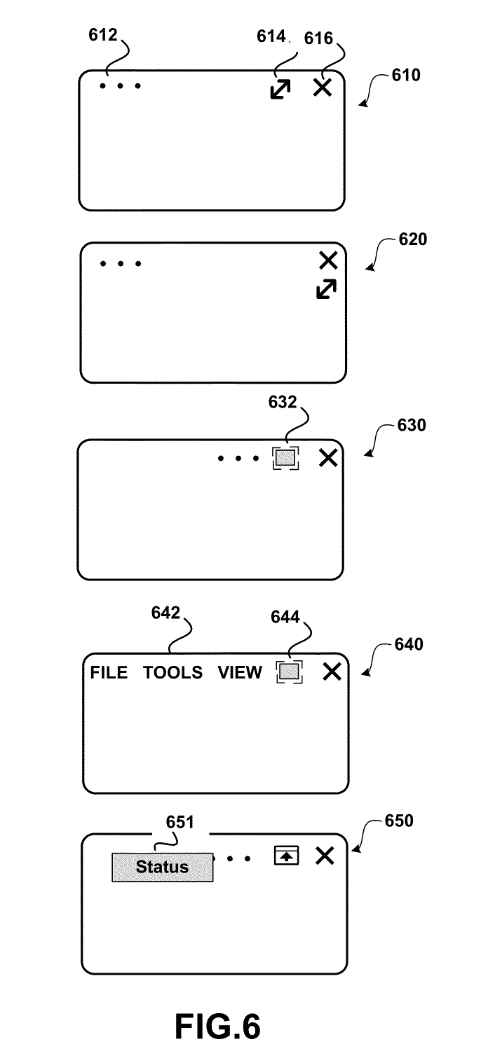

FIG. 6 illustrates exemplary displays showing different embodiments. As illustrated, FIG. 6 includes displays 610, 620, 630, 640 and 650.

Display 610 shows a display of a trigger zone UI element 612 with a display of a viewing mode UI element 614 and a close application element 616. Trigger zone UI element 612 is shown when the viewing mode is not an expanded viewing mode. According to an embodiment, viewing mode UI element 614 toggles between the expanded viewing mode and a hidden viewing mode. According to an embodiment, a user may select a menu option (not shown) to move to a collapsed viewing mode. According to another embodiment, the viewing mode UI element 614 may be used to cycle through each of the available viewing modes (e.g. hidden, collapsed and expanded).

Display 620 shows the display of the UI elements in different locations.

Display 630 shows a display of a different viewing mode UI element 632. Selection of viewing mode UI element 632 displays menu items 642 as shown in display 640. Selection of viewing mode UI element 644 removes commands 642 and moves to display 630.

Display 650 shows a display of a status 651. According to an embodiment, information may be temporarily displayed while in hidden mode to provide the user with more information. The information displayed in status 651 may relate to many different type of information. For example, the status may provide the user with information relating to the current document (e.g. another user is editing the document, the document is updated, a newer version exists, . . . ) as well as other information such as a message has been received, and the like.

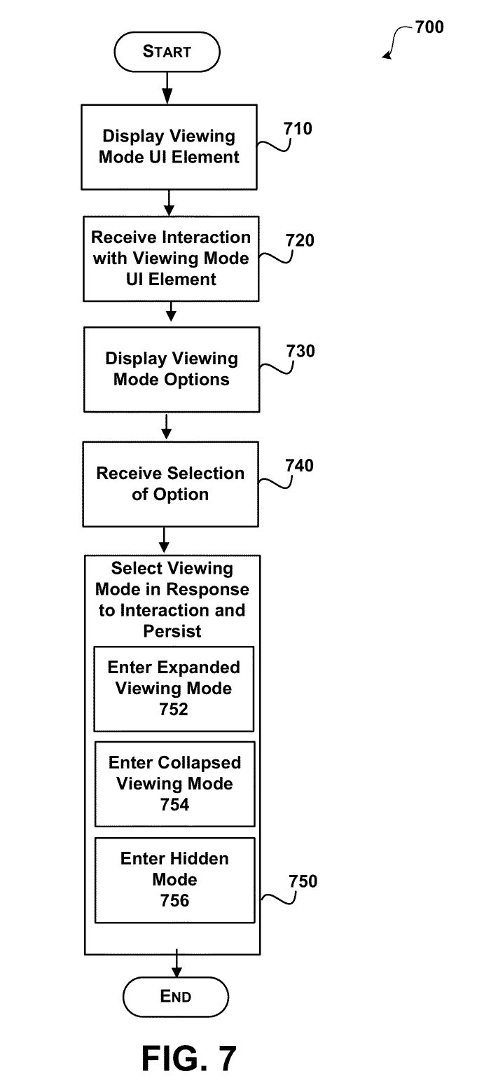

FIG. 7 shows an illustrative processes 700 for changing viewing mode for an application. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process moves to operation 710, where a viewing mode user interface element is displayed. The viewing mode UI element is displayed such that a user may select the UI element to change between viewing modes. According to an embodiment, the viewing mode UI element is persistently displayed regardless of the viewing mode selected.

Flowing to operation 720, user interaction with the viewing mode UI element is detected. According to an embodiment, a touch input gesture (e.g. tapping the viewing mode User Interface (UI) element) is received to display the available viewing modes. Other input may also be used to select the viewing mode UI element (e.g. hardware, speech, motion, . . . ).

Moving to operation 730, the viewing modes for selection are displayed. According to an embodiment, the viewing modes include a hidden mode, a collapsed mode and an expanded mode. More/less viewing modes may also be included.

Transitioning to operation 740, a selection is received. According to an embodiment, a user taps on a viewing mode option to change the viewing mode. Other interaction may also be used to change the viewing mode as described herein (e.g. swiping gesture, pinch/stretch gesture . . . ).

Flowing to operation 750, the viewing mode is selected in response to the selection. When the selection is the expanded mode, the viewing mode changes to the expanded mode 752. When the selection is the collapsed mode, the viewing mode changes to the collapsed mode 754. When the selection is the hidden mode, the viewing mode changes to the hidden mode 752. According to an embodiment, the selected viewing mode is persisted across the application closing/exiting and opening/starting.

The process then moves to an end operation and returns to processing other actions.

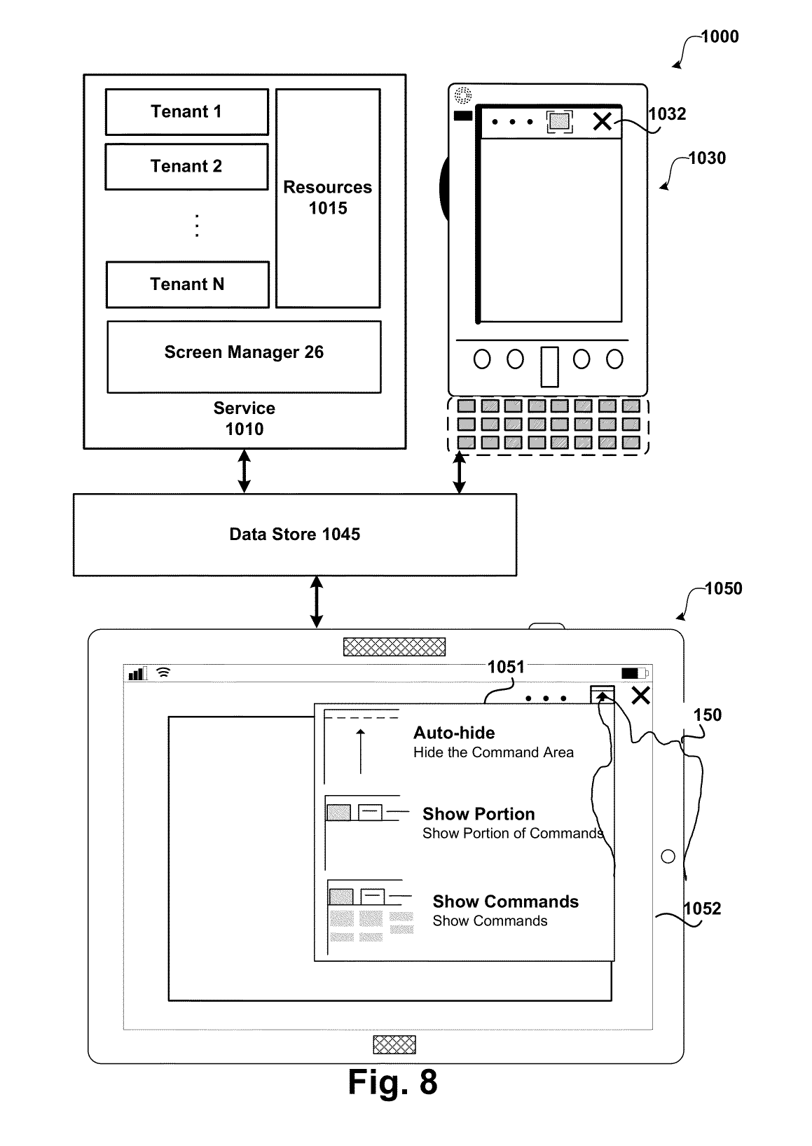

FIG. 8 illustrates an exemplary system for changing viewing modes. As illustrated, system 1000 includes service 1010, data store 1045, touch screen input device/display 1050 (e.g. a slate) and smart phone 1030.

As illustrated, service 1010 is a cloud based and/or enterprise based service that may be configured to provide services, such as productivity services (e.g. MICROSOFT OFFICE 365 or some other cloud based/online service that is used to interact with content (e.g. spreadsheets, documents, presentations, charts, messages, and the like). The service may be interacted with using different types of input/output. For example, a user may use touch input, hardware based input, speech input, and the like. The service may provide speech output that combines pre-recorded speech and synthesized speech. Functionality of one or more of the services/applications provided by service 1010 may also be configured as a client/server based application. Although system 1000 shows a service relating to a productivity application, other services/applications may be configured.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device/display 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030 and touch screen input device/display 1050 are configured with productivity applications.

As illustrated, touch screen input device/display 1050 and smart phone 1030 shows exemplary displays 1052/1032 showing the use of an application. Display 1052 illustrates a user performing a tap gesture to display menu 1051. Data may be stored on a device (e.g. smart phone 1030, slate 1050 and/or at some other location (e.g. network data store 1045). The applications used by the devices may be client based applications, server based applications, cloud based applications and/or some combination.

Screen manager 26 is configured to perform operations relating to changing viewing modes as described herein. While manager 26 is shown within service 1010, the functionality of the manager may be included in other locations (e.g. on smart phone 1030 and/or slate device 1050).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

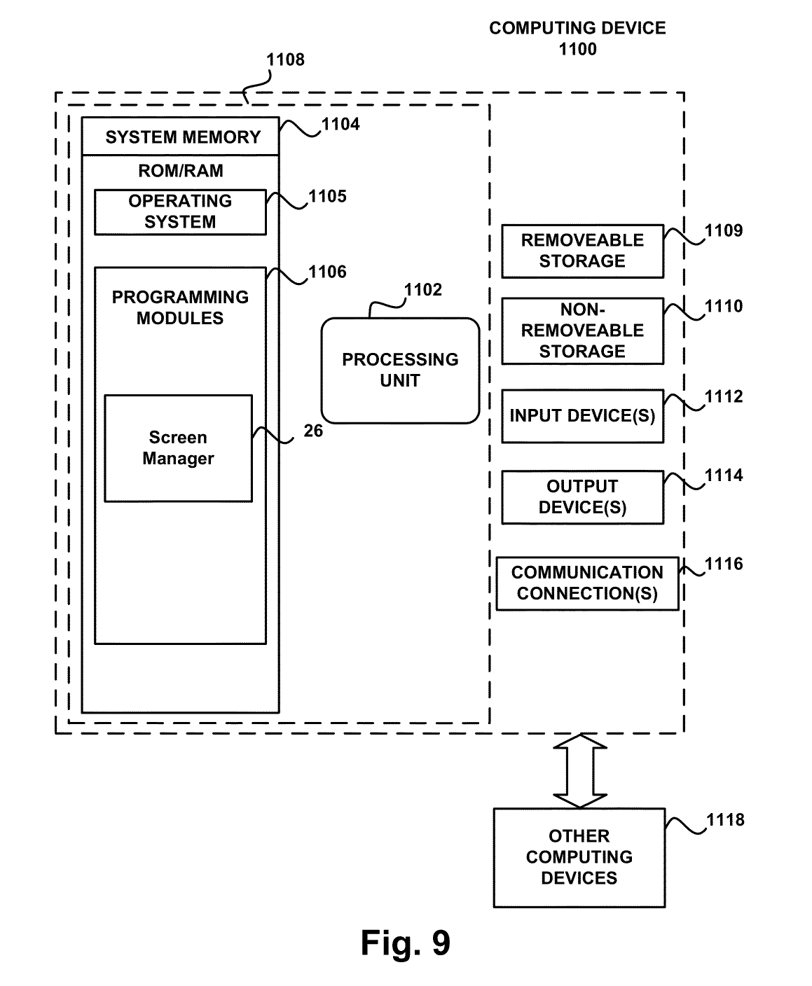

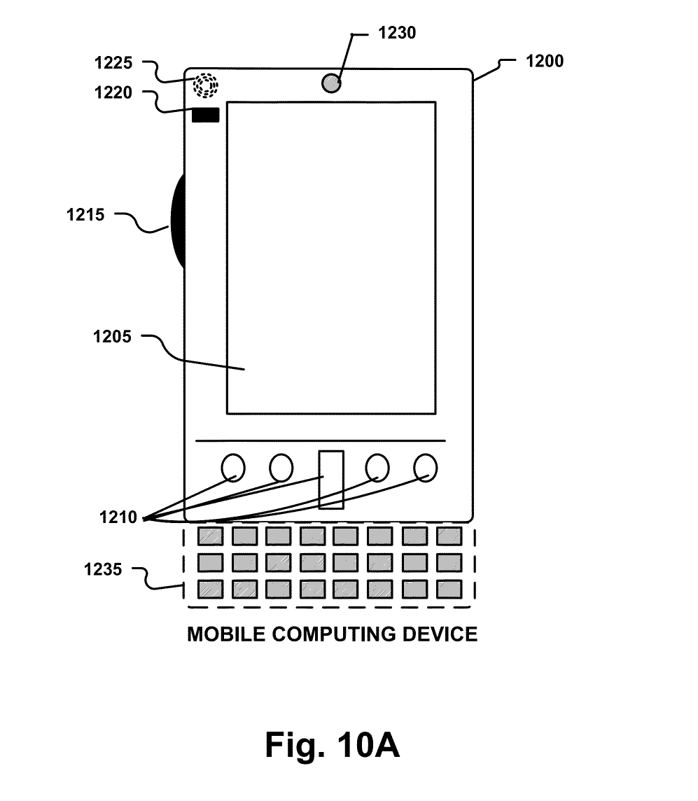

FIGS. 9-11 and the associated descriptions provide a discussion of a variety of operating environments in which embodiments of the invention may be practiced. However, the devices and systems illustrated and discussed with respect to FIGS. 9-11 are for purposes of example and illustration and are not limiting of a vast number of computing device configurations that may be utilized for practicing embodiments of the invention, described herein.

FIG. 9 is a block diagram illustrating example physical components of a computing device 1100 with which embodiments of the invention may be practiced. The computing device components described below may be suitable for the computing devices described above. In a basic configuration, computing device 1100 may include at least one processing unit 1102 and a system memory 1104. Depending on the configuration and type of computing device, system memory 1104 may comprise, but is not limited to, volatile (e.g. random access memory (RAM)), non-volatile (e.g. read-only memory (ROM)), flash memory, or any combination. System memory 1104 may include operating system 1105, one or more programming modules 1106, and may include a web browser application 1120. Operating system 1105, for example, may be suitable for controlling computing device 1100's operation. In one embodiment, programming modules 1106 may include a screen manager 26, as described above, installed on computing device 1100. Furthermore, embodiments of the invention may be practiced in conjunction with a graphics library, other operating systems, or any other application program and is not limited to any particular application or system. This basic configuration is illustrated in FIG. 9 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated by a removable storage 1109 and a non-removable storage 1110.

As stated above, a number of program modules and data files may be stored in system memory 1104, including operating system 1105. While executing on processing unit 1102, programming modules 1106, such as the manager may perform processes including, for example, operations related to methods as described above. The aforementioned process is an example, and processing unit 1102 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 26 may be operated via application-specific logic integrated with other components of the computing device/system 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, etc. Output device(s) 1114 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

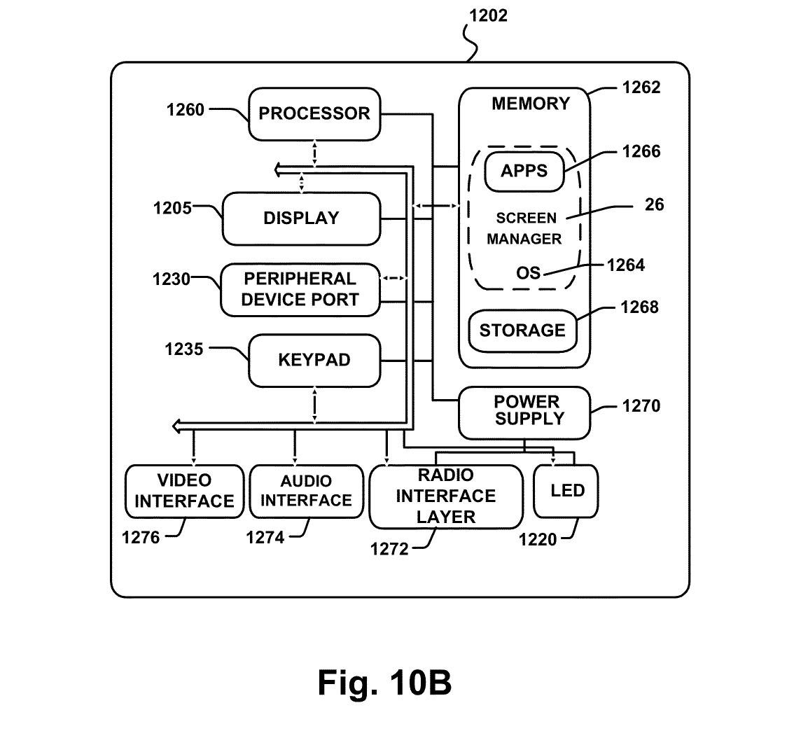

FIGS. 10A and 10B illustrate a suitable mobile computing environment, for example, a mobile telephone, a smartphone, a tablet personal computer, a laptop computer, and the like, with which embodiments of the invention may be practiced. With reference to FIG. 10A, an example mobile computing device 1200 for implementing the embodiments is illustrated. In a basic configuration, mobile computing device 1200 is a handheld computer having both input elements and output elements. Input elements may include touch screen display 1205 and input buttons 1215 that allow the user to enter information into mobile computing device 1200. Mobile computing device 1200 may also incorporate an optional side input element 1215 allowing further user input. Optional side input element 1215 may be a rotary switch, a button, or any other type of manual input element. In alternative embodiments, mobile computing device 1200 may incorporate more or less input elements. For example, display 1205 may not be a touch screen in some embodiments. In yet another alternative embodiment, the mobile computing device is a portable phone system, such as a cellular phone having display 1205 and input buttons 1215. Mobile computing device 1200 may also include an optional keypad 1235. Optional keypad 1215 may be a physical keypad or a “soft” keypad generated on the touch screen display.

Mobile computing device 1200 incorporates output elements, such as display 1205, which can display a graphical user interface (GUI). Other output elements include speaker 1225 and LED light 1220. Additionally, mobile computing device 1200 may incorporate a vibration module (not shown), which causes mobile computing device 1200 to vibrate to notify the user of an event. In yet another embodiment, mobile computing device 1200 may incorporate a headphone jack (not shown) for providing another means of providing output signals.

Although described herein in combination with mobile computing device 1200, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 10B is a block diagram illustrating components of a mobile computing device used in one embodiment, such as the computing device shown in FIG. 10A. That is, mobile computing device 1200 can incorporate system 1202 to implement some embodiments. For example, system 1202 can be used in implementing a “smart phone” that can run one or more applications similar to those of a desktop or notebook computer such as, for example, presentation applications, browser, e-mail, scheduling, instant messaging, and media player applications. In some embodiments, system 1202 is integrated as a computing device, such as an integrated personal digital assistant (PDA) and wireless phoneme.

One or more application programs 1266 may be loaded into memory 1262 and run on or in association with operating system 1264. Examples of application programs include phone dialer programs, e-mail programs, PIM (personal information management) programs, word processing programs, spreadsheet programs, Internet browser programs, messaging programs, and so forth. System 1202 also includes non-volatile storage 1268 within memory 1262. Non-volatile storage 1268 may be used to store persistent information that should not be lost if system 1202 is powered down. Applications 1266 may use and store information in non-volatile storage 1268, such as e-mail or other messages used by an e-mail application, and the like. A synchronization application (not shown) may also reside on system 1202 and is programmed to interact with a corresponding synchronization application resident on a host computer to keep the information stored in non-volatile storage 1268 synchronized with corresponding information stored at the host computer. As should be appreciated, other applications may be loaded into memory 1262 and run on the device 1200, including the screen manager 26, described above.

System 1202 has a power supply 1270, which may be implemented as one or more batteries. Power supply 1270 might further include an external power source, such as an AC adapter or a powered docking cradle that supplements or recharges the batteries.

System 1202 may also include a radio 1272 that performs the function of transmitting and receiving radio frequency communications. Radio 1272 facilitates wireless connectivity between system 1202 and the “outside world”, via a communications carrier or service provider. Transmissions to and from radio 1272 are conducted under control of OS 1264. In other words, communications received by radio 1272 may be disseminated to application programs 1266 via OS 1264, and vice versa.

Radio 1272 allows system 1202 to communicate with other computing devices, such as over a network. Radio 1272 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1202 is shown with two types of notification output devices; LED 1220 that can be used to provide visual notifications and an audio interface 1274 that can be used with speaker 1225 to provide audio notifications. These devices may be directly coupled to power supply 1270 so that when activated, they remain on for a duration dictated by the notification mechanism even though processor 1260 and other components might shut down for conserving battery power. LED 1220 may be programmed to remain on indefinitely until the user takes action to indicate the powered-on status of the device. Audio interface 1274 is used to provide audible signals to and receive audible signals from the user. For example, in addition to being coupled to speaker 1225, audio interface 1274 may also be coupled to a microphone 1220 to receive audible input, such as to facilitate a telephone conversation. In accordance with embodiments of the present invention, the microphone 1220 may also serve as an audio sensor to facilitate control of notifications, as will be described below. System 1202 may further include video interface 1276 that enables an operation of on-board camera 1230 to record still images, video stream, and the like.

A mobile computing device implementing system 1202 may have additional features or functionality. For example, the device may also include additional data storage devices (removable and/or non-removable) such as, magnetic disks, optical disks, or tape. Such additional storage is illustrated in FIG. 12B by storage 1268. Computer storage media may include volatile and nonvolatile, removable and non-removable media implemented in any method or technology for storage of information, such as computer readable instructions, data structures, program modules, or other data.

Data/information generated or captured by the device 1200 and stored via the system 1202 may be stored locally on the device 1200, as described above, or the data may be stored on any number of storage media that may be accessed by the device via the radio 1272 or via a wired connection between the device 1200 and a separate computing device associated with the device 1200, for example, a server computer in a distributed computing network such as the Internet. As should be appreciated such data/information may be accessed via the device 1200 via the radio 1272 or via a distributed computing network. Similarly, such data/information may be readily transferred between computing devices for storage and use according to well-known data/information transfer and storage means, including electronic mail and collaborative data/information sharing systems.

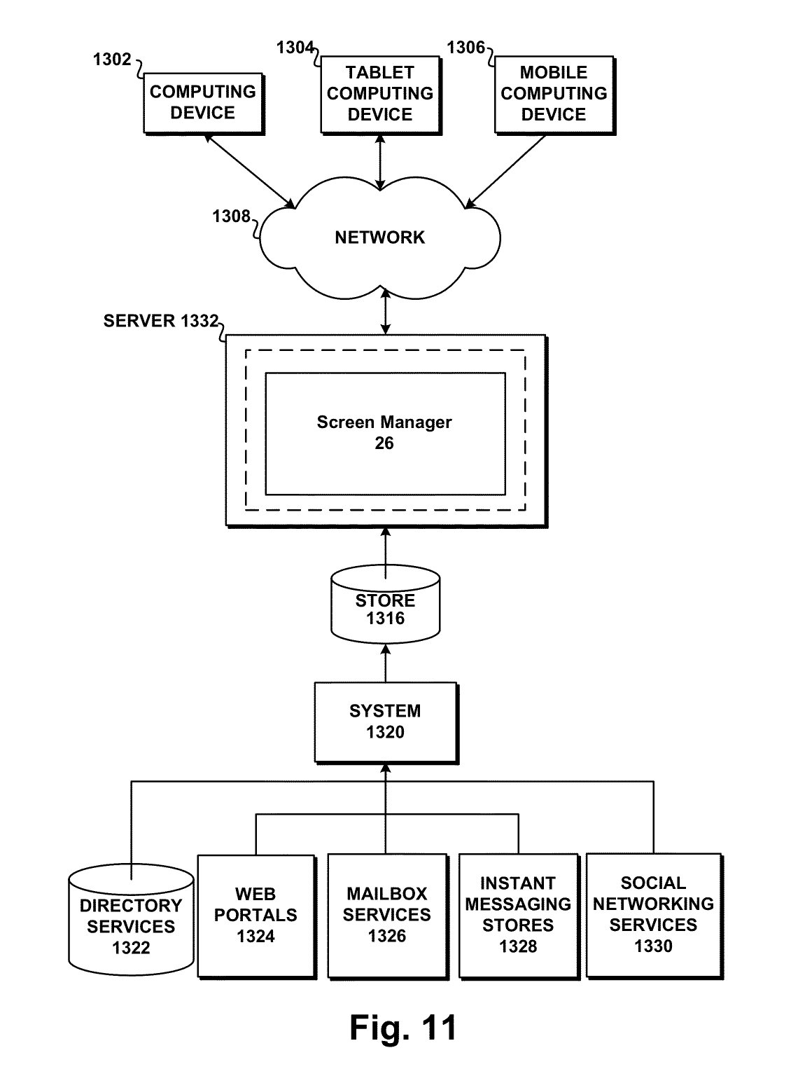

FIG. 11 illustrates a system architecture for changing a viewing mode for an application.

Components managed via the screen manager 26 may be stored in different communication channels or other storage types. For example, components along with information from which they are developed may be stored using directory services 1322, web portals 1324, mailbox services 1326, instant messaging stores 1328 and social networking sites 1330. The systems/applications 26, 1320 may use any of these types of systems or the like for enabling management and storage of components in a store 1316. A server 1332 may provide communications and services relating to creating an application using shared code across different platforms. Server 1332 may provide services and content over the web to clients through a network 1308. Examples of clients that may utilize server 1332 include computing device 1302, which may include any general purpose personal computer, a tablet computing device 1304 and/or mobile computing device 1306 which may include smart phones. Any of these devices may obtain display component management communications and content from the store 1316.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for changing a viewing mode, comprising:
persistently displaying a viewing mode User Interface (UI) element while in different viewing modes that affect a number of commands displayed;
receiving a selection of the viewing mode UI element;
in response to receiving the selection of the viewing mode UI element, displaying at least three viewing mode options for changing a current viewing mode of an application;
receiving a selected viewing mode from of one of the at least one of the three viewing mode options;
changing the current viewing mode to the selected viewing mode; and
persisting the current viewing mode across opening and closing of the application.

2. The method of claim 1, wherein the at least three viewing mode options comprise a hidden mode where commands are hidden, a collapsed mode where a portion of the commands are hidden, and an expanded mode where the commands are shown.

3. The method of claim 1, wherein persistently displaying the viewing mode UI element comprises displaying a trigger zone UI element that when selected temporarily displays commands not currently shown in the current viewing mode.

4. The method of claim 1, wherein receiving the selection of the viewing mode UI element, comprises receiving a touch gesture.

5. The method of claim 1, further comprising receiving a swipe gesture to change the current viewing mode to a next viewing mode.

6. The method of claim 1, wherein changing the current viewing mode to the selected viewing mode comprises: hiding a display of a ribbon user interface when the hidden mode is selected, displaying a portion of the ribbon user interface when the collapsed mode is selected and displaying the ribbon user interface when the expanded mode is selected.

7. The method of claim 1, further comprising displaying a trigger zone UI element and a close application UI element with the display of the viewing mode UI element.

8. The method of claim 3, wherein the temporary display of the commands is removed in response to receiving a selection within the application.

9. The method of claim 1, further comprising displaying the UI elements at a top portion of a display.

10. A computer-readable medium storing computer-executable instructions for changing a viewing mode, comprising:
persistently displaying a viewing mode User Interface (UI) element while in different viewing modes that affect a number of commands displayed;
receiving a selection of the viewing mode UI element;
in response to receiving the selection of the viewing mode UI element, displaying viewing mode options comprising: a hidden mode that when selected commands are hidden, a collapsed mode that when selected hides a portion of the commands, and an expanded mode that when selected shows the commands;
receiving a selected viewing mode;
changing the current viewing mode to the selected viewing mode; and
persisting the current viewing mode across opening and closing of the application.

11. The computer-readable medium of claim 10, wherein persistently displaying the viewing mode UI element comprises displaying a trigger zone UI element that when selected temporarily displays commands not currently shown in the current viewing mode.

12. The computer-readable medium of claim 11, wherein the temporary display of the commands is removed in response to receiving a selection within the application.

13. The computer-readable medium of claim 10, wherein receiving the selection of the viewing mode UI element, comprises receiving a touch gesture.

14. The computer-readable medium of claim 10, further comprising receiving a swipe gesture to change the current viewing mode to a next viewing mode.

15. The computer-readable medium of claim 10, wherein changing the current viewing mode to the selected viewing mode comprises: hiding a display of a ribbon user interface when the hidden mode is selected, displaying a portion of the ribbon user interface when the collapsed mode is selected and displaying the ribbon user interface when the expanded mode is selected.

16. The computer-readable medium of claim 10, further comprising temporarily displaying a status while the viewing mode is one of either: the hidden mode and the collapsed mode.

17. A system for changing a viewing mode, comprising:
a display that is configured to receive touch input;
a processor and memory;
an operating environment executing using the processor;
a display; and
a screen manager that is configured to perform actions comprising:
persistently displaying a viewing mode User Interface (UI) element on the display while in different viewing modes that affect a number of commands displayed;
receiving a selection of the viewing mode UI element;
in response to receiving the selection of the viewing mode UI element, displaying viewing mode options comprising: a hidden mode that when selected commands are hidden, a collapsed mode that when selected hides a portion of the commands, and an expanded mode that when selected shows the commands;
receiving a selected viewing mode;
changing the current viewing mode to the selected viewing mode; and
persisting the current viewing mode across opening and closing of the application.

18. The system of claim 17, wherein persistently displaying the viewing mode UI element comprises displaying a trigger zone UI element that when selected temporarily displays commands not currently shown in the current viewing mode.

19. The system of claim 17, wherein receiving the selection of the viewing mode UI element, comprises receiving a touch gesture.

20. The system of claim 17, wherein changing the current viewing mode to the selected viewing mode comprises: hiding a display of a ribbon user interface when the hidden mode is selected, displaying a portion of the ribbon user interface when the collapsed mode is selected and displaying the ribbon user interface when the expanded mode is selected.
